(19) United States
(12) Patent Application Publication
(10) Pub. No.: US 2026/0221032 A1
(43) Pub. Date: Jul. 30, 2026

(54) VIRTUAL-DEDICATED-LANE CONSTRUCTION SYSTEM, VIRTUAL-DEDICATED-LANE CONSTRUCTION METHOD, AND RECORDING MEDIUM

(71) Applicant: NEC Corporation, Tokyo (JP)

(72) Inventors: Toshihiro WATANABE, Tokyo (JP); Shintaro CHIKU, Tokyo (JP)

(73) Assignee: NEC Corporation, Tokyo (JP)

(21) Appl. No.: 19/159,032

(22) PCT Filed: Feb. 28, 2023
(86) PCT No.: PCT/JP2023/007443

§ 371 Date: Aug. 22, 2025

(51) Int. Cl. G08G 1/0967; G08G 1/04

(52) U.S. Cl. CPC G08G 1/096766; G08G 1/04; G08G 1/096741

(57) ABSTRACT

This virtual-dedicated-lane construction system comprises: an entry detection means for detecting an entry of a prescribed priority vehicle into a prescribed road section; a pathway direction identification means for detecting an object present ahead of said priority vehicle; and a pathway securing means for executing processing according to the object present ahead of the priority vehicle so that said object does not obstruct the pathway of the priority vehicle.

### TECHNICAL FIELD

The present invention relates to a virtual-dedicated-lane construction system, a virtual-dedicated-lane construction method, and a recording medium.

### BACKGROUND ART

PTL 1 discloses a communication method capable of achieving appropriate passage by each mobile body in a traffic situation in which mobile bodies having different operation modes such as a manual driving mode and an automatic driving mode are mixed.

### CITATION LIST

### Patent Literature

PTL 1: JP 2015-228152 A

### SUMMARY OF INVENTION

### Technical Problem

In the method of PTL 1, each mobile body needs to have a function of exchanging a communication frame including identification information of a mode type. In the method of PTL 1, when there is even one mobile body that does not have a function of exchanging the communication frame, it is necessary to take another means for preventing an accident with the mobile body.

An object of the present disclosure is to provide a virtual-dedicated-lane construction method that makes it possible to give priority to a specific vehicle as necessary without requiring each mobile body to be equipped with a dedicated device, and a recording medium.

### Solution to Problem

According to a first aspect, there is provided a virtual-dedicated-lane construction system including an entry detection means for detecting an entry of a prescribed priority vehicle into a prescribed road section, a pathway direction identification means for detecting an object in front of the priority vehicle from an image, and a pathway securing means for executing processing according to the object in front of the priority vehicle in such a way that the object does not obstruct a pathway of the priority vehicle.

According to a second aspect, there is provided a virtual dedicated lane configuration method including detecting that a prescribed priority vehicle has entered a prescribed road section, detecting an object in front of the priority vehicle from an image, and performing processing according to the object in such a way that the object in front of the priority vehicle does not obstruct a pathway of the priority vehicle.

According to a third aspect, there is provided a recording medium recording a program for causing a computer to execute a process of detecting that a prescribed priority vehicle has entered a prescribed road section, a process of detecting an object in front of the priority vehicle from an image, and a process of performing processing according to the object in front of the priority vehicle in such a way that the object does not obstruct a pathway of the priority vehicle.

### Advantageous Effects of Invention

According to the present disclosure, a virtual-dedicated-lane construction method and a recording medium capable of prioritizing a specific vehicle only when necessary are provided.

### BRIEF DESCRIPTION OF DRAWINGS

FIG. 1 is a diagram illustrating a configuration of one example embodiment of the present disclosure.

FIG. 2 is a flowchart illustrating an operation of one example embodiment of the present disclosure.

FIG. 3 is a diagram for describing an operation of an example embodiment of the present disclosure.

FIG. 4 is a diagram for describing an operation of an example embodiment of the present disclosure.

FIG. 5 is a diagram for describing another operation of an example embodiment of the present disclosure.

FIG. 6 is a diagram for describing another operation of an example embodiment of the present disclosure.

FIG. 7 is a diagram illustrating a configuration of a first example embodiment of the present disclosure.

FIG. 8 is a diagram for describing a concept of a range monitored by a virtual-dedicated-lane construction system according to the first example embodiment of the present disclosure.

FIG. 9 is a flowchart illustrating an operation of the virtual-dedicated-lane construction system according to the first example embodiment of the present disclosure.

FIG. 10 is a diagram for describing an operation of the virtual-dedicated-lane construction system of the first example embodiment of the present disclosure.

FIG. 11 is a diagram illustrating a configuration of a second example embodiment of the present disclosure.

FIG. 12 is a diagram for describing an operation of a virtual-dedicated-lane construction system of the second example embodiment of the present disclosure.

FIG. 13 is a diagram illustrating a configuration of a computer constituting a communication terminal of the present disclosure.

### EXAMPLE EMBODIMENT

First, an outline of example embodiments of the present disclosure will be described with reference to the drawings. Reference numerals assigned in the drawings of the outline are assigned to each element for convenience as an example for the sake of convenience to facilitate understanding, and are not intended to limit the present disclosure to any mode shown in drawings. An individual connection line between blocks in the drawings and the like referred to in the following description includes both bidirectional and unidirectional. A unidirectional arrow schematically indicates a flow of a principal signal (data), and does not exclude bidirectionality. A program is executed by a computer apparatus, and the computer apparatus includes, for example, a processor, a storage device, an input device, a communication interface, and a display device as necessary. The computer apparatus is configured to be communicable with devices (including a computer) inside or outside the device via a communication interface in a wired or wireless manner. Although there are ports and interfaces at connection points of input and output of each block in the relevant drawings, illustration of the port or interface is omitted.

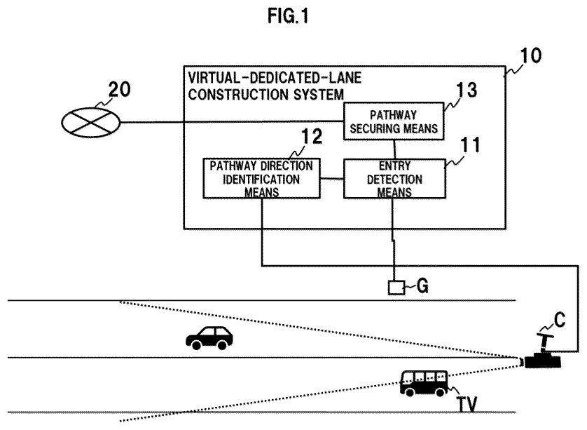

In an example embodiment thereof, as illustrated in FIG. 1, the present disclosure can be achieved by a virtual-dedicated-lane construction system 10 including an entry detection means 11, a pathway direction identification means 12, and a pathway securing means 13.

More specifically, the entry detection means 11 detects that a prescribed priority vehicle TV has entered a prescribed road section. As the prescribed priority vehicle TV, a vehicle required to operate with high punctuality, such as a shared bus or a road work vehicle, is assumed. As a mechanism for identifying these vehicles, a method can be adopted in which a road-to-vehicle communication device (gate device) G is provided at a start point of the prescribed road section, and entry of the target vehicle TV from the device is detected. It is possible to adopt a method of installing a camera C at the start point of the target section and detecting that the target vehicle has entered by object recognition. As the camera C, an in-vehicle camera mounted on a vehicle traveling in the vicinity can also be used.

In a case where there are a position management system that manages the position of the priority vehicle TV and a remote management system that controls the priority vehicle TV from a remote place, a configuration in which the entry detection means 11 acquires the position of the priority vehicle TV from these systems and detects entry into a prescribed road section can also be adopted. In this case, there is an advantage that the installation of the above-described road-to-vehicle communication device (gate device) G and the like can be omitted.

The pathway direction identification means 12 detects an object in front of the priority vehicle TV from the image obtained by the camera C. As a method of detecting an object, a method of detecting an object from a difference from a reference image obtained by photographing a road in a state where there is no object can be adopted. It is also possible to adopt a method of detecting an object in front of the priority vehicle TV using an object recognition technology. Specifically, a method of detecting an object (vehicle or foreign object) in an image using a classifier or the like obtained by performing machine learning or the like using learning data prepared in advance can be used.

The pathway securing means 13 performs processing relevant to the object in front of the priority vehicle so that the object does not obstruct a pathway of the priority vehicle. Specific examples thereof will be described later.

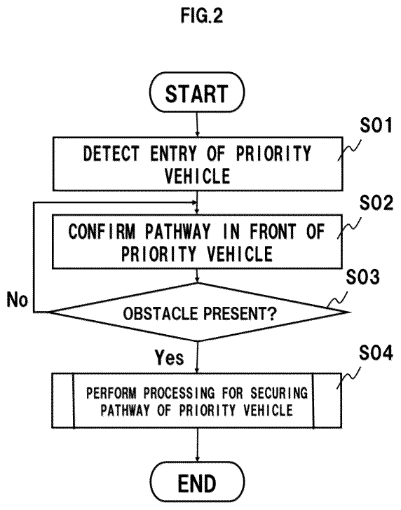

The virtual-dedicated-lane construction system 10 configured as described above operates as follows. First, the virtual-dedicated-lane construction system 10 detects that the priority vehicle has entered a prescribed road section (step S01 in FIG. 2).

Next, the virtual-dedicated-lane construction system 10 confirms the situation of the road in front of the priority vehicle from the image obtained by the camera C (step S02).

As a result of the checking, in a case where there is an object (obstacle) in front of the priority vehicle (Yes in step S03), the virtual-dedicated-lane construction system 10 performs prescribed processing for securing a pathway of the priority vehicle (step S04). In a case where there is no object (obstacle) in front of the priority vehicle (No in step S03), the virtual-dedicated-lane construction system 10 returns to step S 02 and continues monitoring.

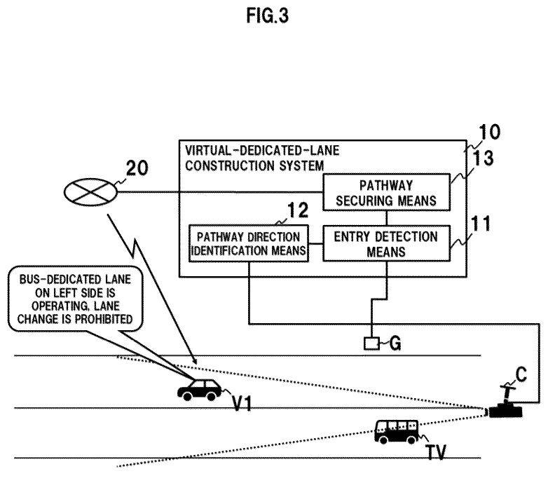

Here, an example of the prescribed processing performed by the virtual-dedicated-lane construction system 10 in step S 04 will be described. FIG. 3 is a diagram for describing an example thereof. As illustrated in FIG. 3, in a case where the vehicle V1 is traveling in the adjacent lane in front of the priority vehicle TV, when a vehicle V1 moves to the same lane as the priority vehicle TV, there is a possibility that the traveling of the priority vehicle TV is hindered. In this case, the virtual-dedicated-lane construction system 10 transmits a message requesting the vehicle V1 not to change the lane via a network 20 as illustrated in FIG. 3. As illustrated in FIG. 3, this message may include contents indicating that a specific lane is in operation as a bus-dedicated lane. In this way, the effect of the message can be enhanced.

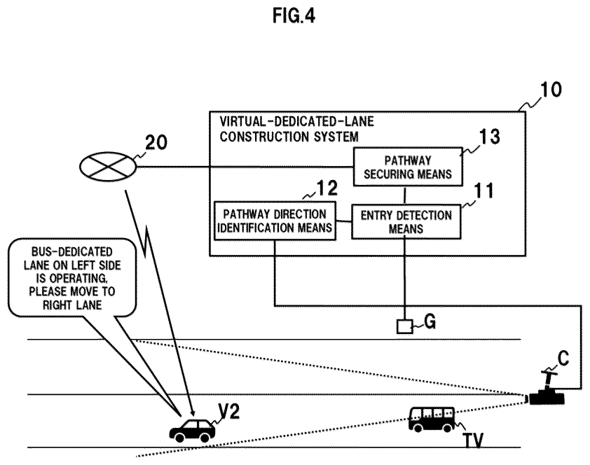

FIG. 4 is a diagram for describing another example of the prescribed processing performed by the virtual-dedicated-lane construction system 10. In the example of FIG. 4, a vehicle V2 is located in the same lane as the priority vehicle TV. In this case, if the vehicle V2 is at a low speed or is stopped, there is a possibility that the traveling of the priority vehicle TV is hindered. In this case, the virtual-dedicated-lane construction system 10 transmits a message requesting the vehicle V2 to move from the left lane via the network 20 as illustrated in FIG. 4. As illustrated in FIG. 4, this message can also include contents indicating that a specific lane is in operation as a bus-dedicated lane, thereby encouraging cooperation of the vehicle V2. In the example of FIG. 4, the message requesting the vehicle V2 to move from the left lane is transmitted to the vehicle V2. However, in a case where the vehicle V2 is stopped, a message instructing the vehicle V2 to start may be transmitted to the vehicle V2. Similarly, in a case where the vehicle V2 is traveling at a low speed, a message instructing acceleration may be transmitted to the vehicle V2.

As illustrated in FIGS. 3 and 4, as a method by which the virtual-dedicated-lane construction system 10 transmits a specific message to the vehicles V1 and V2 via the network 20, a method using road-to-vehicle communication, a method using a mobile communication network, or the like can be considered. As a method of identifying the vehicles V1 and V2 at this time, the entry detection means 11 may specify the vehicles V1 and V2, and may inquire a vehicle management device or the like that manages the vehicles arranged on the cloud side of the transmission address or the like. The messages addressed to the vehicles V1 and V2 may be transmitted in the form of data for causing an in-vehicle terminal mounted on the vehicles V1 and V2 to display a message or output a voice.

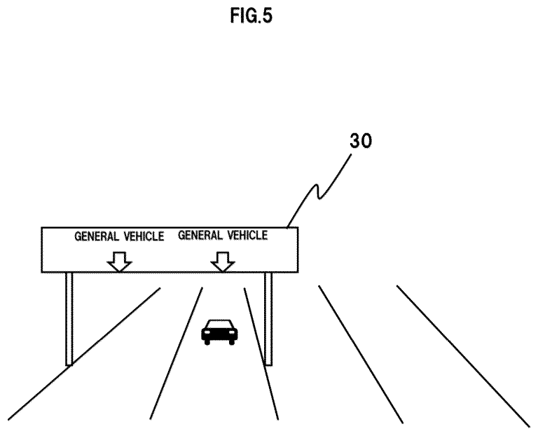

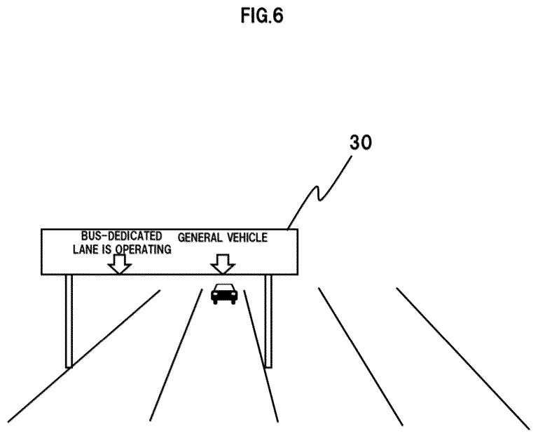

The prescribed processing performed by the virtual-dedicated-lane construction system 10 is not limited to transmission of a message to each vehicle. For example, as illustrated in FIGS. 5 and 6, the virtual-dedicated-lane construction system 10 may perform processing of displaying information indicating a lane type on an electric bulletin board (road information display board) 30 installed on a side or an upper part of a road. In this case, the virtual-dedicated-lane construction system 10 transmits data for displaying a message on the electric bulletin board 30 installed in the prescribed road section. FIG. 5 illustrates a state of the electric bulletin board (road information display board) 30 before the priority vehicle enters a prescribed road section, and the two lanes on the left side are both lanes for general vehicles. FIG. 6 illustrates a state of the electric bulletin board (road information display board) 30 after the priority vehicle enters a prescribed road section, and the left lane of the two lanes is a bus-dedicated lane. In a case where the relevant road is equipped with lane lighting equipment as described in PTL 1, lane lighting can be used instead of the electric bulletin board (road information display board) 30 to indicate the lane type.

The prescribed processing performed by the virtual-dedicated-lane construction system 10 is not limited to the above example. For example, in a case where the vehicles V1 and V2 are provided with an information display function by augmented reality (AR) or mixed reality (MR), these technologies may be used to present a message for prohibiting a lane change or prompting movement from a lane in which the vehicle is traveling.

According to the virtual-dedicated-lane construction system 10 operating as described above, it is possible to construct a lane that gives priority to passage of a specific priority vehicle only when necessary at low cost.

### First Example Embodiment

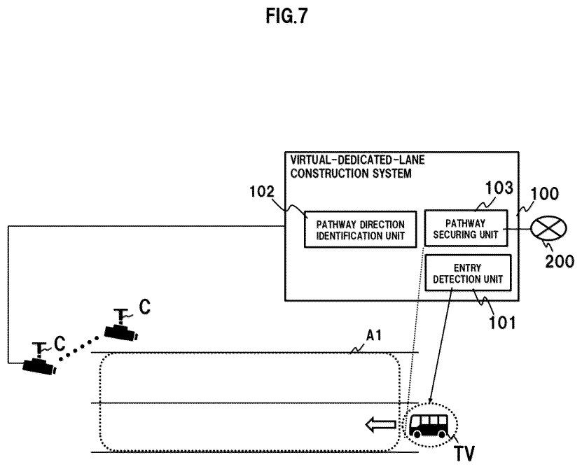

Next, a first example embodiment in which a route bus is set as a priority vehicle and can contribute to improvement of punctuality will be described in detail with reference to the drawings. FIG. 7 is a diagram illustrating a configuration of the first example embodiment of the present disclosure. Referring to FIG. 7, a configuration in which a virtual-dedicated-lane construction system 100 and a plurality of cameras C are connected is illustrated.

A necessary number of cameras C are arranged along the course of the route bus which is the priority vehicle TV. The camera C is not necessarily a dedicated camera, and for example, a camera for measuring a traffic flow or observing a traffic jam may be used.

The virtual-dedicated-lane construction system 100 includes an entry detection unit 101, a pathway direction identification unit 102, and a pathway securing unit 103.

The entry detection unit 101 detects that the priority vehicle TV has entered a prescribed road section. As the entry detection unit 101, a terminal installed at a bus stop such as a starting point of a route bus may be used. In a case where there is a control system or the like that manages the operation of the priority vehicle TV, it is also possible to adopt a configuration in which the entry detection unit 101 acquires position information of the priority vehicle TV from the control system or the like and detects entry into a prescribed road section. Examples of the position information include global positioning system (GPS) position information, real time kinematic (RTK) position information, and management position information (distance from a bus stop) used in these systems.

The pathway direction identification unit 102 operates while the priority vehicle TV is traveling on a prescribed road section, monitors a prescribed range Al in the pathway direction of the priority vehicle TV from the image obtained by the camera C, and detects an object in front of the priority vehicle TV. As a method of detecting an object, a method of detecting an object from a difference from the reference image or a method using an object recognition technology can be adopted, similarly to the pathway direction identification means 12.

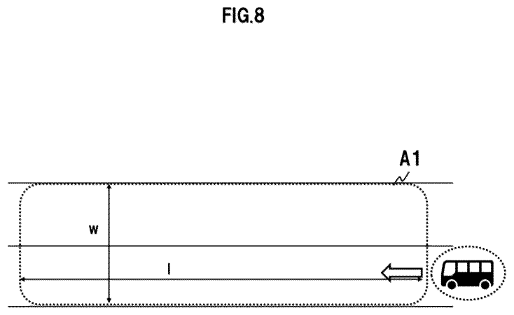

FIG. 8 illustrates the range Al monitored by the virtual-dedicated-lane construction system 100 of the present example embodiment. The range A1 can take a substantially rectangular shape having a length l and a width w. The length l is defined by the cruise speed of the priority vehicle TV, an assumed type of obstacle, and the like. In a case where the cruise speed of the priority vehicle TV is high, the length l is set to a value larger than that in a case where the cruise speed of the priority vehicle TV is low. In a case where the assumed type of obstacle is an object that takes time to move or remove, such as a parked vehicle, the length l is set to a larger value. In a case where visibility of the road is good, the length L may be set to be equal to or more than several 100 m. The width w is defined by the number of lanes of the relevant road, the assumed type of obstacle, and the like. In a case where the number of lanes of the relevant road is large, a larger value may be set as the width w. In a case where a lane change is prohibited in the relevant road section, w may be a width relevant to one lane ahead of the priority vehicle TV. Although the rectangular range Al is illustrated in the example of FIG. 8, the range Al may have an elliptical shape or a fan shape.

The pathway securing unit 103 operates while the priority vehicle TV is traveling on a prescribed road section, and performs processing according to the type and the state of the object so that the object in front of the priority vehicle does not obstruct the pathway of the priority vehicle. As described above, the entry detection unit 101, the pathway direction identification unit 102, and the pathway securing unit 103 are relevant to the entry detection means, the pathway direction identification means, and the pathway securing means.

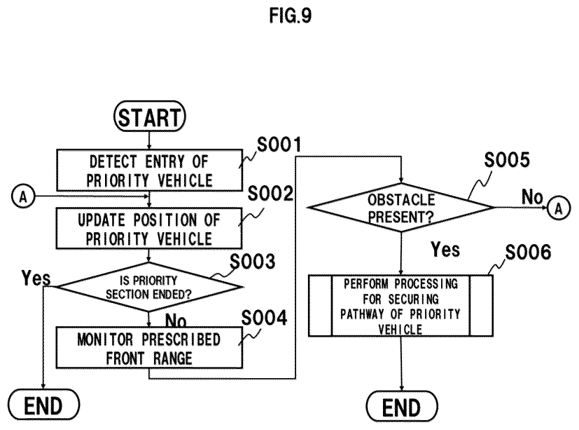

Next, the operation of the present example embodiment will be described in detail with reference to the drawings. FIG. 9 is a flowchart illustrating an operation of the virtual-dedicated-lane construction system 100 according to the first example embodiment of the present disclosure. Referring to FIG. 9, first, when detecting entry of the priority vehicle TV (step S001), the virtual-dedicated-lane construction system 100 updates the position of the priority vehicle TV (step S002). The position of the priority vehicle TV may be acquired from the priority vehicle TV by road-to-vehicle communication, or may be estimated by the virtual-dedicated-lane construction system 100 from the speed of the priority vehicle TV, the operation schedule of the priority vehicle TV, and the like.

The virtual-dedicated-lane construction system 100 determines whether the position of the priority vehicle TV is within the priority section (relevant to a prescribed road section) (step S003). As a result of the determination, in a case where the position of the priority vehicle TV is outside the priority section, the virtual-dedicated-lane construction system 100 ends the subsequent processing (Yes in step S003).

On the other hand, in a case where the position of the priority vehicle TV is within the priority section, the virtual-dedicated-lane construction system 100 monitors the prescribed range Al in front of the priority vehicle TV (step S004). In a case where no obstacle is found by the monitoring, the virtual-dedicated-lane construction system 100 skips the subsequent processing and returns to step S002 to continue updating and monitoring the position of the priority vehicle TV (No in step S005).

On the other hand, in a case where an obstacle is found by the monitoring, the virtual-dedicated-lane construction system 100 performs processing according to the type and the state of the object (step S006). Examples of the processing include, but are not limited to, various types of processing illustrated in FIGS. 3 to 6. For example, in the example of FIG. 3, a message requesting not to change the lane is transmitted to the vehicle VI traveling in the adjacent lane, but the content of the message can be changed depending on the type and state of the target vehicle. For example, in a case where the vehicle VI is a self-driving vehicle or a vehicle equipped with an advanced driving assistance system, a mode of transmitting a control message to the ECU of the vehicle V1 can also be adopted. In this case, for example, the virtual-dedicated-lane construction system 100 can notify the ECU of the vehicle V1 that the priority vehicle V1 is approaching from behind, and can suppress the lane change.

Similarly, in the example of FIG. 4, the message requesting the vehicle V2 preceding in the same lane to move to the right lane is transmitted. However, in a case where the vehicle V2 is a self-driving vehicle or a vehicle equipped with an advanced driving assistance system, a mode of transmitting a control message to the ECU of the vehicle V2 can also be adopted. In this case, for example, the virtual-dedicated-lane construction system 100 can notify the ECU of the vehicle V2 that the priority vehicle V1 is approaching from behind, and cause the vehicle V2 to change the lane, start, accelerate, and the like.

A case where the vehicle V2 preceding in the same lane is parked is also assumed. In this case, the virtual-dedicated-lane construction system 100 can also notify a road manager or a person in charge of the police of the presence of the vehicle V2. The virtual-dedicated-lane construction system 100 may notify the priority vehicle TV of the presence of the vehicles V1 and V2.

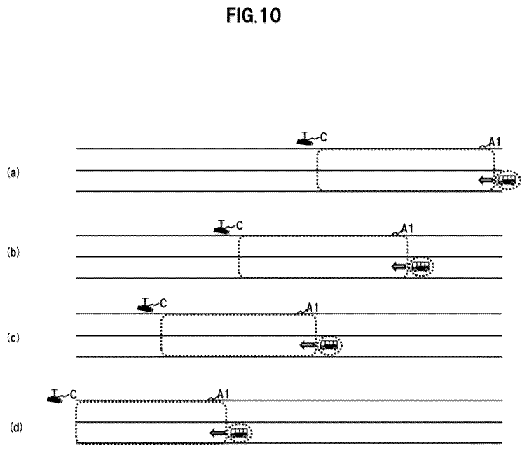

As described in the above operation, as illustrated in (a) to (d) of FIG. 10, the virtual-dedicated-lane construction system 100 continues monitoring while moving the prescribed range A1 using the plurality of cameras C as the priority vehicle TV moves. Therefore, even if the route of the priority vehicle TV is long, it is possible to accurately find and deal with an obstacle.

### Second Example Embodiment

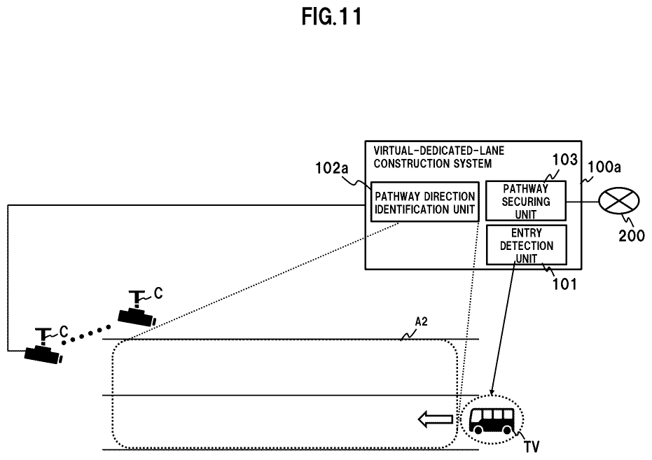

Next, a second example embodiment in which a range monitored by the virtual-dedicated-lane construction system is fixed will be described. FIG. 11 is a diagram illustrating a configuration of the second example embodiment of the present disclosure. The difference from the first example embodiment illustrated in FIG. 7 is the function of a pathway direction identification unit 102a provided in a virtual-dedicated-lane construction system 100a. Since the other configurations are similar to those of the first example embodiment, the differences thereof will be mainly described below.

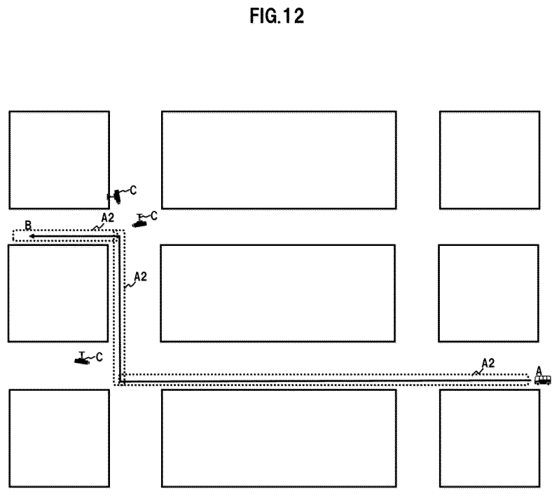

The pathway direction identification unit 102a of the present example embodiment operates while the priority vehicle TV is traveling on a prescribed road section, monitors a prescribed range A2 in the pathway direction of the priority vehicle TV from the image obtained by the camera C, and detects an object in front of the priority vehicle TV. FIG. 12 is a diagram illustrating a prescribed range A2 monitored by the virtual-dedicated-lane construction system 100a. In the example of FIG. 12, an area required to be monitored on the travel route (point A to point B) of the priority vehicle TV is divided into a plurality of ranges A2 that can be seen from the camera C, and is monitored by the pathway direction identification unit 102a. The pathway direction identification unit 102a detects an object by switching the monitoring range as the priority vehicle TV moves.

In the present example embodiment, since it is not strictly necessary to chase the priority vehicle TV, there is an advantage that an existing monitoring camera installed near the travel route of the priority vehicle can be used. The position of the priority vehicle TV can be substituted by the position determined from the operation schedule of the priority vehicle TV, and there is an advantage that it is not necessary to grasp the accurate position of the priority vehicle TV.

Although each of the example embodiments of the present disclosure is described above, the present disclosure is not limited to the above-described example embodiments, and further modifications, substitutions, and adjustments can be made without departing from the basic technical idea of the present disclosure. For example, the network configuration, the configuration of each element, and the representation form of data that are illustrated in the drawings are merely examples that facilitate understanding of the present disclosure, and the present disclosure is not limited to those illustrated in the drawings.

### (Hardware Configuration)

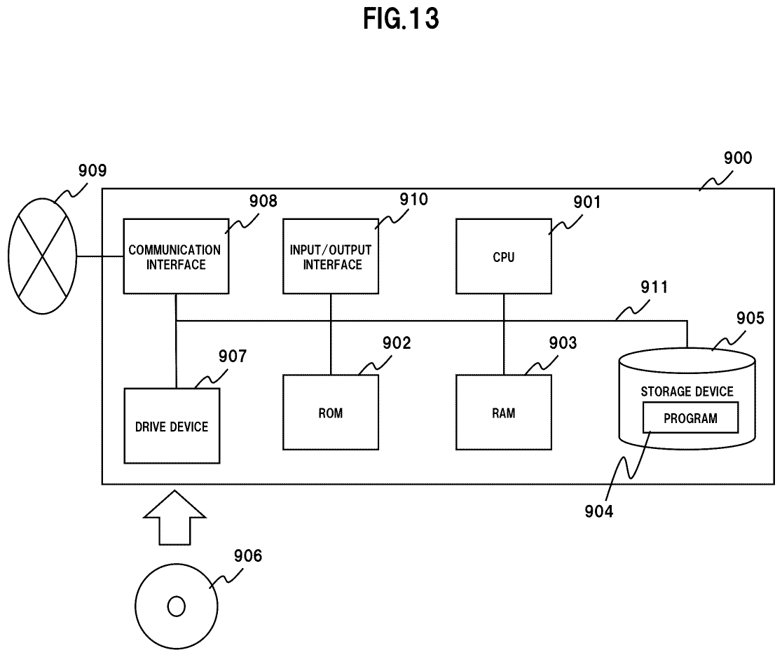

In each of the example embodiments of the present disclosure, each component of the apparatuses indicates a block of a functional unit. A part or all of the components of the apparatuses is achieved by, for example, any combination of an information processing apparatus 900 and a program, as illustrated in FIG. 13. FIG. 13 is a block diagram illustrating an example of a hardware configuration of the information processing apparatus 900 that achieves each component of each apparatus. The information processing apparatus 900 includes the following configuration as an example.
Central processing unit (CPU) 901
Read only memory (ROM) 902
Random access memory (RAM) 903
Program 904 loaded onto RAM 903
Storage device 905 that stores program 904
Drive device 907 that reads from and writes into recording medium 906
Communication interface 908 connected with communication network 909
Input/output interface 910 for inputting/outputting data
Bus 911 connecting between components

The components of the apparatuses in the example embodiments are achieved by the CPU 901 acquiring and executing the program 904 for achieving the functions. That is, the CPU 901 in FIG. 13 may execute a entry detection program and a message transmission program to perform update processing of calculation parameters stored in the RAM 903, the storage device 905, or the like. The program 904 for achieving the functions of the components of the apparatuses is stored in the storage device 905 or the ROM 902 in advance, for example, and is read by the CPU 901 as necessary. The program 904 may be supplied to the CPU 901 via the communication network 909, or may be stored in advance in the recording medium 906 to be read by the drive device 907 and supplied to the CPU 901.

Various modifications exist for the method of achieving the apparatuses. For example, the apparatuses may be achieved by any combination of the information processing apparatus 900 and individual programs for each component. A plurality of components included in the apparatuses may be achieved by any combination of one information processing apparatus 900 and one program. That is, units (processing means and functions) of a virtual-dedicated-lane construction system described in the first to third example embodiments may be achieved by a computer program that causes a processor mounted in the apparatus to execute the processing described above by using the hardware.

A part or all of the components of the apparatuses may be achieved by other general-purpose or dedicated circuits, processors, and the like, or a combination thereof. The circuits and the like may be configured by a single chip or may be configured by a plurality of chips connected to each other via a bus.

A part or all of the components of the apparatuses may be achieved by a combination of the above-described circuits and the like and a program.

When a part or all of the components of the apparatuses is achieved by a plurality of information processing apparatuses, circuits, and the like, the plurality of information processing apparatuses, circuits, and the like may be arranged to be centralized or to be distributed. For example, the information processing apparatus, the circuit, and the like may be achieved as a form such as a client and server system or a cloud computing system in which the apparatuses or the like are connected via a communication network.

The above-described example embodiments are preferred example embodiments of the present disclosure, and the scope of the present disclosure is not limited only to the above-described example embodiments. That is, it is possible for those skilled in the art to modify or substitute the above-described example embodiments and construct a mode in which various modifications are made without departing from the gist of the present disclosure.

For example, in the first and second example embodiments described above, an example in which the priority vehicle TV is a route bus has been described, but the priority vehicle TV may be another vehicle. For example, a self-driving vehicle or a vehicle requiring advanced assistance may be set as the priority vehicle TV. In the method described in the background art, a large initial investment is required for lane lighting, but according to the method of the present disclosure, the cost can be greatly suppressed. According to the method of the present disclosure, since the priority processing is performed only when the priority vehicle TV enters the relevant section, there is no problem that other traffic is obstructed more than necessary in other time zones.

A part or all of the above example embodiments may be described as the following Supplementary Notes, but are not limited to the following.

### Supplementary Note 1

A virtual-dedicated-lane construction system including:
an entry detection means for detecting an entry of a prescribed priority vehicle into a prescribed road section;
a pathway direction identification means for detecting an object in front of the priority vehicle from an image obtained by a camera; and
a pathway securing means for executing processing according to the object in front of the priority vehicle in such a way that the object does not obstruct a pathway of the priority vehicle.

### Supplementary Note 2

In the virtual-dedicated-lane construction system described above, it is possible to adopt a configuration in which, in a case where the object is a vehicle traveling in an adjacent lane adjacent to a lane in which the priority vehicle is traveling, the pathway securing means transmits, to the traveling vehicle, a message for preventing a lane change to the lane in which the priority vehicle is traveling.

### Supplementary Note 3

In the virtual-dedicated-lane construction system described above, it is possible to adopt a configuration in which, in a case where the object is a vehicle that stops in a lane in which the priority vehicle is traveling or is traveling in the same lane as the lane in which the priority vehicle is traveling, the pathway securing means transmits a message instructing the vehicle to move from the lane.

### Supplementary Note 4

In the virtual-dedicated-lane construction system described above, it is possible to adopt a configuration in which, in a case where the object is a vehicle stopped in a lane in which the priority vehicle is traveling, the pathway securing means transmits a message instructing the vehicle to start.

### Supplementary Note 5

In the virtual-dedicated-lane construction system described above, it is possible to adopt a configuration in which the message is transmitted in a form of data for causing an in-vehicle terminal mounted on the vehicle to display the message or output a voice.

### Supplementary Note 6

In the virtual-dedicated-lane construction system described above, it is possible to adopt a configuration in which the message is transmitted in a form of data for displaying the message on an electric bulletin board installed in the prescribed road section.

### Supplementary Note 7

A virtual dedicated lane configuration method including:
detecting that a prescribed priority vehicle has entered a prescribed road section;
detecting an object in front of the priority vehicle from an image obtained by a camera; and
performing processing according to the object in front of the priority vehicle in such a way that the object does not obstruct a pathway of the priority vehicle.

### Supplementary Note 8

A recording medium recording a program for causing a computer to execute:
a process of detecting that a prescribed priority vehicle has entered a prescribed road section;
a process of detecting an object in front of the priority vehicle from an image obtained by a camera; and
a process of performing processing according to the object in front of the priority vehicle in such a way that the object does not obstruct a pathway of the priority vehicle.

The modes described in the above supplementary notes can be combined with each other after making necessary modifications. For example, a configuration having both the content described in Supplementary Note 2 and the content described in any one or more of Supplementary Notes 3 to 6 is also included in the disclosure scope of the present specification.

The forms of the Supplementary Notes 7 and 8 can be expanded to the forms of the Supplementary Notes 2 to 6, similarly to the Supplementary Note 1.

The disclosures of each of the above PTLs is incorporated herein by reference, and may be used as the basis or a part of the present disclosure as necessary. Modifications and adjustments of the example embodiments or examples are possible within the scope of the overall disclosure (including the claims) of present disclosure and based on the basic technical concept of the present disclosure. Various combinations or selections (including partial deletions) of various disclosure elements (including the elements in each of the claims, example embodiments or examples, drawings, and the like) are possible within the scope of the present disclosure. That is, the present disclosure of course includes various variations and modifications that could be made by those skilled in the art in accordance with the technical concept. The description discloses numerical value ranges. However, even if the description does not particularly disclose any numerical values or sub-range included within the ranges, these values and ranges should be construed to have been concretely disclosed. Furthermore, the disclosures of the above-cited documents may be used, in part or in whole, in combination with the descriptions in this document, as part of this disclosure, in accordance with the gist of this disclosure, and such uses are deemed to be included in the disclosures of this application.

### REFERENCE SIGNS LIST

10, 100 virtual-dedicated-lane construction system
11 entry detection means
12 pathway direction identification means
13 pathway securing means
20, 200 network
30 electric bulletin board (road information display board)
101 entry detection unit
102, 102a pathway direction identification unit
103 pathway securing unit
900 information processing apparatus
901 central processing unit (CPU)
902 read only memory (ROM)
903 random access memory (RAM)
904 program
905 storage device
906 recording medium
907 drive device
908 communication interface
909 communication network
910 input/output interface
911 bus
A1, A2 prescribed range
C camera
G road-to-vehicle communication device (gate device)
TV priority vehicle
V1, V2 vehicle

What is claimed is:

1. A virtual-dedicated-lane construction system comprising:
a memory configured to store instructions; and
a processor configured to execute the instructions to:
detect an entry of a prescribed priority vehicle into a prescribed road section;
detect an object in front of the priority vehicle from an image obtained by a camera; and
execute processing according to the object in front of the priority vehicle in such a way that the object does not obstruct a pathway of the priority vehicle.

2. The virtual-dedicated-lane construction system according to claim 1, wherein
in a case where the object is a vehicle traveling in an adjacent lane adjacent to a lane in which the priority vehicle is traveling, the processor transmits, to the traveling vehicle, a message for preventing a lane change to the lane in which the priority vehicle is traveling.

3. The virtual-dedicated-lane construction system according to claim 1, wherein
in a case where the object is a vehicle that stops in a lane in which the priority vehicle is traveling or is traveling in a same lane as the lane in which the priority vehicle is traveling, the processor transmits a message instructing the vehicle to move from the lane.

4. The virtual-dedicated-lane construction system according to claim 1, wherein
in a case where the object is a vehicle stopped in a lane in which the priority vehicle is traveling, the processor transmits a message instructing the vehicle to start.

5. The virtual-dedicated-lane construction system according to claim 2, wherein the message is transmitted in a form of data for causing an in-vehicle terminal mounted on the vehicle to display the message or output a voice.

6. The virtual-dedicated-lane construction system according to claim 2, wherein the message is transmitted in a form of data for displaying the message on an electric bulletin board installed in the prescribed road section.

7. A virtual dedicated lane configuration method comprising:
detecting that a prescribed priority vehicle has entered a prescribed road section;
detecting an object in front of the priority vehicle from an image obtained by a camera; and
performing processing according to the object in front of the priority vehicle in such a way that the object does not obstruct a pathway of the priority vehicle.

8. A non-transitory recording medium recording a program for causing a computer to execute processing comprising:
detecting that a prescribed priority vehicle has entered a prescribed road section;
detecting an object in front of the priority vehicle from an image obtained by a camera; and
performing processing according to the object in front of the priority vehicle in such a way that the object does not obstruct a pathway of the priority vehicle.

9. The virtual-dedicated-lane construction system according to claim 3, wherein the message is transmitted in a form of data for causing an in-vehicle terminal mounted on the vehicle to display the message or output a voice.

10. The virtual-dedicated-lane construction system according to claim 4, wherein the message is transmitted in a form of data for causing an in-vehicle terminal mounted on the vehicle to display the message or output a voice.

11. The virtual-dedicated-lane construction system according to claim 3, wherein the message is transmitted in a form of data for displaying the message on an electric bulletin board installed in the prescribed road section.

12. The virtual-dedicated-lane construction system according to claim 4, wherein the message is transmitted in a form of data for displaying the message on an electric bulletin board installed in the prescribed road section.

13. The virtual-dedicated-lane construction system according to claim 5, wherein the message is transmitted in a form of data for displaying the message on an electric bulletin board installed in the prescribed road section.
